(19) United States
(12) Patent Application Publication
(10) Pub. No.: US 2020/0063477 A1
(43) Pub. Date: Feb. 27, 2020

(54) FASTENING SYSTEM

(71) Applicant: DR. HAHN GMBH & CO. KG, MOENCHENGLADBACH (DE)

(72) Inventors: DOMINIK NEETEN, MOENCHENGLADBACH (DE); MARKUS LENZE, NETTETAL (DE)

(73) Assignee: DR. HAHN GMBH & CO. KG, MOENCHENGLADBACH (DE)

(21) Appl. No.: 16/466,037

(22) PCT Filed: Dec. 19, 2016
(86) PCT No.: PCT/EP2016/081779

§ 371 Date: Jun. 3, 2019

(51) Int. Cl. E05D 5/02; F16B 2/02

(52) U.S. Cl. CPC E05D 5/023; E05D 5/0238; E05Y 2800/272; E05Y 2600/528; F16B 2/02

(57) ABSTRACT

A fastening system includes a profile, a fastening piece, at least two clamping pieces, at least two fasteners, and an elastic element which acts on each of the at least two clamping pieces. Each of the at least two fasteners acts in a direction of force and cooperates with a respective one of the at least two clamping pieces. The profile provides a first contact surface for each of the at least two clamping pieces. The fastening piece provides a second contact surface for each of the at least two clamping pieces.

### CROSS REFERENCE TO PRIOR APPLICATIONS

This application is a U.S. National Phase application under 35 U.S.C. § 371 of International Application No. PCT/EP2016/081779, filed on Dec. 19, 2016. The International Application was published in German on Jun. 28, 2018 as WO 2018/113905 A1 under PCT Article 21(2).

### FIELD

The present invention relates to a fastening system with a profile.

### BACKGROUND

Such fastening profiles have previously been described. They serve, for example, to connect a fitting part, which may be the part of a band for connecting, for example, a door leaf with a frame, to a profile.

A disadvantage of known fastening systems is that they are often not as easy to assemble as desired and/or fail to provide a desirably resilient fastening of the fastening piece to the profile and/or are expensive to manufacture.

### SUMMARY

An aspect of the present invention is to provide a fastening system which improves on at least one of the aforementioned disadvantages.

In an embodiment, the present invention provides a fastening system which includes a profile, a fastening piece, at least two clamping pieces, at least two fasteners, and an elastic element configured to act on each of the at least two clamping pieces. Each of the at least two fasteners is configured to act in a direction of force and to cooperate with a respective one of the at least two clamping pieces. The profile provides a first contact surface for each of the at least two clamping pieces. The fastening piece provides a second contact surface for each of the at least two clamping pieces.

### BRIEF DESCRIPTION OF THE DRAWINGS

The present invention is described in greater detail below on the basis of embodiments and of the drawings in which:

FIG. 1 shows a cross-sectional view of a first exemplary embodiment of a system according to the present invention in a not yet assembled and in a not yet joined state of the profile and of the fastening piece;

FIG. 2 shows a representation as in FIG. 1 in the already joined but not yet fastened state;

FIG. 3 shows a representation as in FIG. 1 in the joined and fastened state;

FIG. 3a shows a detail of FIG. 3 on a slightly larger scale;

FIG. 4 shows a cross-sectional view of a second exemplary embodiment of a system according to the present invention in a state in which the fastening piece has not yet been completely joined with the profile;

FIG. 5 shows a view as in FIG. 4 in the already fully joined state of the fastening piece with the profile, however, in the not yet fastened state;

FIG. 6 shows a view as in FIG. 4, but in the fully joined and fastened state;

FIG. 7 shows a first view of a clamping piece;

FIG. 8 shows a second view of a clamping piece;

FIG. 9 shows a third view of a clamping piece;

FIG. 10 shows a perspective view of a clamping piece on an enlarged scale;

FIG. 11 shows a detail of the exemplary embodiment shown in FIGS. 4-6 in a perspective view and on a larger scale;

FIG. 12 shows a cross-sectional view of a third exemplary embodiment of a system according to the present invention in a state in which the profile and the fastening piece have not yet been assembled and not yet been joined together;

FIG. 13 shows a view as in FIG. 12 in an already joined but not yet fastened state;

FIG. 14 shows a view as in FIG. 12 in the joined and fastened state;

FIG. 15 shows a detail of FIG. 14 on a somewhat larger scale;

FIG. 16 shows one of the two clamping pieces shown in FIG. 12 in a first view;

FIG. 17 shows one of the two clamping pieces shown in FIG. 12 in a second view;

FIG. 18 shows one of the two clamping pieces shown in FIG. 12 in a third view;

FIG. 19 shows a side view as in FIG. 16, but from the opposite side;

FIG. 20 shows a perspective view of one of the two clamping pieces shown in FIG. 12 on an enlarged scale; and

FIG. 21 shows a view as in FIG. 20, but with a view of the other side.

### DETAILED DESCRIPTION

According to a first aspect, the fastening system according to the present invention has a profile. A fixing piece is also provided, as well as at least two clamping pieces. The fastening system also comprises at least two fasteners, each acting in a direction of force, which interact with the clamping pieces. The profile provides first contact surfaces for the clamping pieces and the fastening piece provides second contact surfaces for the clamping pieces. According to this first aspect, an elastic member is provided, which acts on the clamping pieces.

The system is used to fasten the fastening piece to the profile.

A particularly easy assembly of the fastening system may be provided as a result of the elastic element.

The fastening piece may be a band part. In an embodiment, it is not a band part. In an embodiment, it is a fitting part not used for fastening a band.

The fastening system advantageously comprises exactly one elastic element. The elastic element can, for example, act on both clamping pieces.

The fasteners advantageously each comprise a fastening screw or are formed by a fastening screw. It is also conceivable that the fasteners comprise a rivet, such as blind rivet, or are respectively formed thereby. Exactly one fastener can, for example, cooperate with exactly one clamping piece. Each clamping piece can, for example, have a threaded hole for this purpose.

The effect of the elastic element on the clamping pieces may be mediated by another element or other elements, such as the one or more fasteners. The elastic element can thus act on the one or on the multiple fasteners, the one or the multiple of which can transmit this effect onto the clamping pieces.

The profile can, for example, comprise aluminum.

The clamping pieces can, for example, comprise harder material than the profile. In an embodiment, the clamping pieces can, for example, comprise steel.

The fasteners can, for example, pass through the fastening piece.

The fastening piece can, for example, be situated, relative to the main groove further outward than the clamping pieces.

If the elastic element acts between the clamping pieces, then an advantageous assembly of the system can be achieved in a particularly simple and effective manner. The elastic element advantageously elastically draws the clamping pieces together.

The second contact surfaces can, for example comprise slanted guide surfaces for the clamping pieces. The guide surfaces are advantageously slanted so that they do not extend parallel and also not, for example, perpendicularly to the direction of force of the fasteners. The distance of the guide surfaces (in the assembled state of the system) can, for example, increase with increasing depth in the profile in each case to the fasteners, which cooperates with the clamping piece, for which the guide surfaces provide a contact surface. The guide surfaces can be planar or curved. If the guide surfaces are curved, they can, for example, be convex.

The term “direction of force of the fasteners” in the context of the present invention in particular means the direction of the main force produced by these fasteners, for example, in the fully assembled state of the system. In the case of fastening screws, this in particular means the direction from their axis, which is directed toward the fastening piece, for example, in the fully assembled state of the system. The direction of force in the assembled state of the system can, for example, extend perpendicularly to the imaginary plane in which the opening of the groove of the profile is situated.

The clamping pieces are each advantageously wedge-shaped on their side facing the second contact surface. The clamping pieces can thus, for example, each have a slanted counter guide surface on their side facing the second contact surface. The counter guide surface is advantageously slanted so that it does not extend parallel and, for example, also not perpendicularly to the direction of force of the fastener. A displaceability of the clamping pieces from an assembly position to a holding position can thereby be improved.

A precondition may also be advantageously created for producing clamping forces and/or spreading forces via the clamping pieces. The slanted counter guide surface may comprise or be formed by teeth, such as splined teeth.

The system can be particularly easy to assemble if the elastic element is designed so that it provides the positioning of the clamping pieces relative to each other in an assembly position. The elastic element in this embodiment is namely able to relieve the assembler of the task of holding the clamping pieces in an assembly position, for example, when joining the fastening piece to the profile.

If the elastic element allows the clamping pieces to be displaced into a holding position, this then creates another precondition for a particularly easy assembly of the system. The assembler in this case does not need to remove the elastic element, for example, after joining the fastening piece to the profile. The elastic element allows the clamping pieces to be displaced, for example, as the fasteners are fastened in a holding position.

The term “assembly position of the clamping pieces” within the context of the present invention in particular refers to the position of the clamping pieces, for example, relative to each other, in the unassembled state, which enables and/or facilitates the joining of the fastening piece to the profile.

The term “holding position of the clamping pieces” within the context of the present invention in particular means the position of the clamping pieces, which these occupy in the fully assembled state of the fastening system.

The profile advantageously includes a groove. The first contact surfaces can, for example, be provided by side walls of this groove. The two clamping pieces are advantageously situated next to one another in this groove in the assembled state of the system. These two clamping pieces in the assembled state are thus, for example, situated not next to each other in the longitudinal direction of the profile, but perpendicularly thereto.

The distance between the two clamping pieces in the assembly position relative to each other can, for example, be smaller than the width of the opening of the groove, so that these clamping pieces are advantageously easily insertable into the groove in the assembly direction of the joining of the clamping piece and the profile.

The distance of at least sections of two clamping pieces situated next to each other in the groove in their holding position is advantageously larger than the width of the opening of the groove. An interaction between the clamping pieces located in their holding position and the groove, such as a rear grip, is thereby, for example, possible.

The second contact surfaces are advantageously designed so that with their help, the displacement of the clamping pieces from an assembly position into a holding position may be provided by fastening the fasteners. This displacement may advantageously be provided only by fastening the fasteners. With this displacement, the distance of the clamping pieces relative to each other advantageously changes, it can, for example, increase. With this displacement, a tilting of the clamping pieces advantageously takes place, for example, so that the distance between the sections of the clamping pieces that are further away from the fastening piece increases more than the distance between the sections of the clamping pieces that are situated closer to the fastening piece. The term “fastening of the fasteners” means, for example, in the case of a screw as a fastener, the tightening thereof, for example, until the screw produces the desired main force (here tractive force). A simplification of the assembly is achieved insofar as the displacement can, for example, be provided by fastening the fastener, i.e., for example, no further action is necessary therefor.

In an embodiment, the clamping pieces can, for example, include teeth. The longitudinal extension of the teeth is advantageously parallel to the direction of force of the fastener. The teeth can, for example, have a wedge-shaped outer contour, for example, so that they protrude farther from the clamping pieces in sections further away from the fastening piece than in sections situated closer to the fastening piece.

The wedge shape of the clamping pieces can be produced wholly or in part by the teeth. In one embodiment, therefore, the clamping pieces as such are not each already wedge-shaped but acquire this shape only through the teeth.

A positive connection may be advantageously produced as a result of the teeth. The positive connection acts, for example, between the clamping pieces and the fastening piece and, for example, between the clamping pieces and the profile. The positive connection thus acts, for example, between the fastening piece and the profile, for example, mediated by a clamping piece.

In the assembled state, the teeth can, for example, engage in the second contact surface. In an embodiment, the teeth in the assembled state engage in the first contact surface. Furrows, with which the teeth advantageously form-fittingly interlock, may be produced in the first contact surfaces and/or the second contact surfaces by fastening the fastener via the teeth.

In an embodiment, holders for the elastic element can, for example, be provided on the clamping pieces. The elastic element can be a ring made of elastic material, for example, a rubber ring, for example, a so-called 0-ring. The holders may include projections on which the elastic element may rest. In an embodiment, the projections may be situated in recesses of the clamping pieces so that they do not project beyond the outer contour of the clamping pieces. The recesses of the clamping pieces can face each other. The brackets may have heads, against slippage of the elastic element.

In an embodiment, the clamping pieces can, for example, each be wedge-shaped on two opposite sides and/or the first and second contact surfaces extend toward each other in the direction of the force. A precondition can thereby be created for providing that the clamping pieces (advantageously in their holding position) each produce spreading forces between a first contact surface and a second contact surface.

The spreading force can be produced exclusively or partially by the teeth, in particular in the embodiment in which the wedge shape of the clamping pieces is wholly or partially produced by the teeth.

A frictional connection may be advantageously produced between the clamping pieces and the first contact surfaces and, for example, between the clamping pieces and the second contact surfaces. A frictional connection may therefore be produced, for example, between the fastening piece and the profile, for example, mediated by a clamping piece. The force flow of this frictional connection advantageously does not flow through the fastener. A relieving of the fastener may be achieved as a result.

A relative movement between the teeth of the clamping pieces and the contact surfaces may be advantageously produced during the fastening of the fastener, for example, also when the teeth are already in contact with the contact surfaces. A furrow of the teeth may be advantageously produced in the contact surfaces as a result. The teeth advantageously have a tapered outer contour, resulting in a particularly good furrow effect.

In an embodiment, sections of the first contact surfaces can, for example, extend parallel to the direction of force of the fastener, or the first contact surfaces can, for example, extend completely parallel to the direction of force of the fastener. It has been found that even with such contact surfaces, the clamping pieces may be fixed in the direction of the force direction of the fastener.

It is in principal conceivable that sections of the second contact surfaces extend parallel to the direction of force of the fastener, or the second contact surfaces extend completely parallel to the direction of force of the fastener.

In an embodiment, the fastening piece has at least one projection which engages behind a contact surface of the profile extending parallel to the direction of force of the fastener. The projection also advantageously extends parallel to the direction of force of the fastener. The fastening piece thus advantageously engages behind the profile sections which provide these surfaces. As a result, spreading forces of the clamping piece can be supported and/or these sections of the profile may be pinched between the clamping piece and the projection of the fastening piece.

In an embodiment, the clamping pieces can, for example, have a shoulder, in particular in their holding position, on their side facing the first contact surface.

The shoulder can, for example, also be referred to as nose or projection.

In this embodiment, at least sections of the first contact surface in particular advantageously extend perpendicularly to the direction of force of the fastener. The shoulder advantageously engages behind these sections in the holding position of the clamping pieces. The clamping pieces may also have teeth in this embodiment, in particular on their sides facing the second contact surfaces and/or on their sides facing the first contact surfaces.

In an embodiment, the wedge angle of the wedge shape of the clamping pieces can, for example, be less than 45°.

In an embodiment, the clamping pieces can, for example, have teeth on different, for example, on opposite, sides.

In an embodiment, the clamping pieces can, for example, have different teeth. The clamping pieces can, for example, have different teeth on different sides. As a result, the different requirements for the teeth advantageously prevailing on different sides of the clamping pieces can be taken into account.

First teeth can, for example, be provided on one side of the clamping pieces, for example, the side facing the second contact side in the assembled state, the longitudinal extension of which extends advantageously parallel to the direction of force of the fastener, and which can further, for example, have a wedge-shaped outer contour, for example, such that they project further from the clamping pieces in sections further away from the clamping piece than in sections situated closer to the fastening piece. These first teeth advantageously produce or maintain the wedge shape of the clamping pieces, for example, implemented on this side of the clamping pieces. These first teeth can further, for example, produce spreading forces, or the displacement of the clamping pieces from the assembly position into the holding position is accomplished with their assistance. The first teeth may also be referred to as “splined teeth”.

On another, for example, the opposite, and in particular, for example, on the side of the clamping pieces which includes a shoulder, the clamping pieces advantageously include second teeth which do not produce or maintain a wedge shape of the clamping pieces. These second teeth can, for example, originate from the shoulder of the clamping pieces, more specifically, for example, from the surface of the shoulder, with which the shoulder engages behind at least sections of the first contact surface, which advantageously extend perpendicularly to the direction of force of the fastener. These second teeth advantageously point in the direction of the force direction of the fastener. When fastening the fastener, these second teeth are advantageously moved perpendicularly toward this first contact surface and can further, for example, be embedded in this contact surface. A positive connection and/or frictional connection is/are thereby produced between clamping piece and profile. The second teeth may also be referred to as “vertical teeth”.

In an embodiment, the clamping pieces can, for example, include teeth on one side (for example on the side facing the second contact surface) which advantageously produce or maintain a wedge shape of the clamping pieces on this side of the clamping pieces. These teeth may be splined teeth. The clamping pieces can further, for example, include a shoulder on the opposite side, which can, for example, engage behind sections of the first contact surface, which can, further, for example, extend perpendicularly to the direction of force of the fastener. The following advantage can, for example, be achieved as a result: the clamping pieces may be reliably displaced from the assembly position into the holding position and secured in the holding position with the aid of the teeth producing or maintaining the wedge shape, without a defined stop for the clamping pieces being provided on the fastening piece in the direction of force of the fastener. This is because teeth producing or maintaining the wedge shape are able to push slightly further or less far into the fastening piece depending on manufacturing tolerances. It can thereby be provided that the force exerted by the fastener on the clamping pieces is transmitted to a very large extent via the shoulder onto the profile where it results in the desired clamping. It has been found that to achieve this effect, it is helpful if, for example, the wedge angle of the wedge shape of the clamping pieces is less than 45°. As previously stated above, teeth, such as vertical teeth, can also be provided on the shoulder.

In an embodiment, the clamping pieces can, for example, abut the second contact surfaces both in their assembly position, as well as in their holding position.

In an embodiment, the clamping pieces can, for example, abut the second contact surfaces only in their assembly position and are supported in their holding position merely on the first contact surfaces.

According to a second aspect, the fastening system according to the present invention includes a profile. A fixing piece is also provided, as well as at least two clamping pieces. The fastening system also comprises at least two fasteners, each acting in a direction of force, which interact with the clamping pieces. The profile provides first contact surfaces for the clamping pieces and the fastening piece provides second contact surfaces for the clamping pieces.

According to this second aspect, the clamping pieces are each wedge-shaped on their side facing the second contact surface.

An elastic element is advantageously provided, which can, for example, act on the clamping pieces.

The system is used to fasten the fastening piece to the profile.

A particularly easy assembly of the fastening system may be provided as a result of the elastic element.

The fastening piece may be a band part. In an embodiment, it is not a band part. In an embodiment, it is a fitting part not used for fastening a band.

The fastening system advantageously comprises exactly one elastic element. The elastic element can, for example, act on both clamping pieces.

The fasteners advantageously each comprise a fastening screw or are formed by a fastening screw. It is also conceivable that the fasteners comprises a rivet, such as blind rivet, or are respectively formed thereby. Exactly one fastener can, for example, cooperate with exactly one clamping piece. Each clamping piece can, for example, has a threaded hole therefor.

The effect of the elastic element on the clamping pieces may be mediated by another element or other elements, such as the one or more fastener. The elastic element can thus act on the one or on the multiple fastener(s), the one or the multiple of which can transmit this effect onto the clamping pieces.

The profile can, for example, comprise aluminum.

The clamping pieces can, for example, comprise harder material than the profile. In an embodiment, the clamping pieces can, for example, comprise steel.

The fasteners can, for example, pass through the fastening piece.

The fastening piece can, for example, be situated, relative to the main groove, further outward than the clamping pieces.

If the elastic element acts between the clamping pieces, then an advantageous assembly of the system can be achieved in a particularly simple and effective manner. The elastic element advantageously elastically draws the clamping pieces together.

The second contact surfaces can, for example, comprise slanted guide surfaces for the clamping pieces. The guide surfaces are advantageously slanted so that they do not extend parallel and, for example, also not perpendicularly to the direction of force of the fasteners. The distance of the guide surfaces (in the assembled state of the system) can, for example, increase with an increasing depth in the profile in each case to the fasteners, which cooperates with the clamping piece, for which the guide surfaces provide a contact surface. The guide surfaces can be planar or curved. If they are curved, they can, for example, be convex.

The term “direction of force of the fastener” in the context of the present invention in particular means the direction of the main force produced by the fasteners, for example, in the fully assembled state of the system. In the case of fastening screws, this in particular means the direction from their axis, which is directed toward the fastening piece, for example, in the fully assembled state of the system. The direction of force in the assembled state of the system can, for example, extend perpendicularly to the imaginary plane in which the opening of the groove of the profile is situated.

If the clamping pieces are each wedge-shaped on their side facing the second contact surface, then the clamping pieces can, for example, each have a slanted counter-guide surface on their side facing the second contact surface. The counter guide surface is advantageously slanted so that it does not extend parallel and, for example, also not perpendicularly to the direction of force of the fastener. A displaceability of the clamping pieces from an assembly position to a holding position can thereby be improved.

A precondition may additionally be advantageously created for producing clamping forces and/or spreading forces via the clamping pieces. The slanted counter guide surface may comprise or be formed by teeth, such as splined teeth.

The clamping pieces may each be wedge-shaped on two opposite sides and/or the first and second contact surfaces may extend towards each other in the direction of force. A precondition can thereby be created for providing that the clamping pieces (advantageously in their holding position) each produce spreading forces between a first contact surface and a second contact surface.

The system can be particularly easy to assemble if the elastic element is designed so that it provides the positioning of the clamping pieces relative to each other in an assembly position. The elastic element in this embodiment is namely able to relieve the assembler of the task of holding the clamping pieces in an assembly position, for example, when joining the fastening piece to the profile.

If the elastic element allows the clamping pieces to be displaced into a holding position, this then creates another precondition for a particularly easy assembly of the system. The assembler in this case does not need to remove the elastic element, for example, after joining the fastening piece to the profile. The elastic element allows the clamping pieces to be displaced, for example, as the fasteners are fastened in a holding position.

The term “assembly position of the clamping pieces” within the context of the present invention in particular refers to the position of the clamping pieces, for example, relative to each other, in the unassembled state, which enables and/or facilitates the joining of the fastening piece to the profile.

The term “holding position of the clamping pieces” within the context of the present invention in particular means the position of the clamping pieces, which these occupy in the fully assembled state of the fastening system.

The profile advantageously includes a groove. The two clamping pieces are advantageously situated next to one another in this groove in the assembled state of the system. These two clamping pieces in the assembled state are thus, for example, situated not next to each other in the longitudinal direction of the profile, but perpendicularly thereto.

The distance between the two clamping pieces in the assembly position relative to each other can, for example, be smaller than the width of the opening of the groove, so that these clamping pieces are advantageously easily insertable into the groove in the assembly direction of the joining of the clamping piece and the profile.

The distance of at least sections of two clamping pieces situated next to each other in the groove in their holding position is advantageously larger than the width of the opening of the groove. An interaction between the clamping pieces located in their holding position and the groove, such as a rear grip, is thereby, for example, possible.

The second contact surfaces are advantageously designed so that with their help, the displacement of the clamping pieces from an assembly position into a holding position may be provided by fastening the fasteners. This displacement may advantageously be provided only by fastening the fasteners. With this displacement, the distance of the clamping pieces relative to each other advantageously changes, it can, for example, increase. With this displacement, a tilting of the clamping pieces advantageously takes place, for example, so that the distance between the sections of the clamping pieces that are further away from the fastening piece increases more than the distance between the sections of the clamping pieces that are situated closer to the fastening piece. The term “fastening of the fastener” means, for example, in the case of a screw as a fastener, the tightening thereof, for example, until the screw produces the desired main force (here tractive force). A simplification of the assembly is achieved insofar as the displacement can, for example, be provided by fastening the fastener, for example, no further action is necessary for this purpose.

In an embodiment, the clamping pieces can, for example, include teeth. The longitudinal extension of the teeth is advantageously parallel to the direction of force of the fastener. The teeth can, for example, have a wedge-shaped outer contour, for example, so that they protrude farther from the clamping pieces in sections further away from the fastening piece than in sections situated closer to the fastening piece.

The wedge shape of the clamping pieces can be produced wholly or partly by the teeth. In an embodiment, the clamping pieces as such are therefore not each already wedge-shaped, but acquire this shape only through the teeth.

As a result of the teeth, a positive connection may be advantageously produced. The positive connection can, for example, act between the clamping pieces and the fastening piece and further, for example, between the clamping pieces and the profile. The positive connection can thus act, for example, between the fastening piece and the profile, for example, mediated by a clamping piece.

In the assembled state, the teeth can, for example, engage in the second contact surface. In an embodiment, the teeth in the assembled state can, for example, engage in the first contact surface. Furrows, with which the teeth advantageously form-fittingly interlock, may be produced in the first contact surfaces and/or the second contact surfaces by fastening the fastener(s) via the teeth.

In an embodiment, the wedge angle of the wedge shape of the clamping pieces can, for example, be less than 45°.

In an embodiment, the clamping pieces can, for example, have teeth on different, for example, on opposite, sides.

In an embodiment, the clamping pieces can, for example, have different teeth. The clamping pieces can, for example, have different teeth on different sides. As a result, the different requirements for the teeth advantageously prevailing on different sides of the clamping pieces can be taken into account.

First teeth can, for example, be provided on one side of the clamping pieces (for example, the side facing the second contact side in the assembled state), the longitudinal extension of which extends advantageously parallel to the direction of force of the fasteners, and which can, for example, further have a wedge-shaped outer contour, for example, so that they project further from the clamping pieces in sections further away from the clamping piece than in sections situated closer to the fastening piece. These first teeth advantageously produce or maintain the wedge shape of the clamping pieces which are, for example, implemented on this side of the clamping pieces. These first teeth can, for example, further produce spreading forces, or the displacement of the clamping pieces from the assembly position into the holding position is accomplished with their assistance. The first teeth may also be referred to as “splined teeth”.

On another, for example, the opposite, and in particular, for example, on the side of the clamping pieces which includes a shoulder, the clamping pieces advantageously include second teeth which do not produce or maintain a wedge shape of the clamping pieces. These second teeth can, for example, originate from the shoulder of the clamping pieces, more specifically, for example, from the surface of the shoulder, with which the shoulder engages behind at least sections of the first contact surface, which advantageously extend perpendicularly to the direction of force of the fasteners. These second teeth advantageously point in the direction of the force direction of the fasteners. When fastening the fasteners, these second teeth are advantageously moved perpendicularly toward this first contact surface and can, for example, be embedded in this contact surface. A positive connection and/or frictional connection is/are thereby produced between clamping piece and profile. The second teeth may also be referred to as “vertical teeth”.

In an embodiment, the clamping pieces can, for example, include teeth on one side (for example, on the side facing the second contact surface) which advantageously produce or maintain a wedge shape of the clamping pieces on this side of the clamping pieces. These teeth may be splined teeth. The clamping pieces can, for example, further include a shoulder on the opposite side, which can, for example, engage behind sections of the first contact surface, which can, for example, further extend perpendicularly to the direction of force of the fasteners. The following advantage can, for example, be achieved as a result: the clamping pieces may be reliably displaced from the assembly position into the holding position and secured in the holding position with the aid of the teeth producing or maintaining the wedge shape, without a defined stop for the clamping pieces being provided on the fastening piece in the direction of force of the fasteners. This is because teeth producing or maintaining the wedge shape are able to push slightly further or less far into the fastening piece depending on manufacturing tolerances. It can thereby be provided that the force exerted by the fasteners on the clamping pieces is transmitted to a very large extent via the shoulder onto the profile where it results in the desired clamping. It has been found that to achieve this effect, it is helpful if, for example, the wedge angle of the wedge shape of the clamping pieces is less than 45°. As previously stated above, teeth, such as vertical teeth, can also be provided on the shoulder.

In an embodiment, holders for the elastic element can, for example, be provided on the clamping pieces. The elastic element can be a ring made of elastic material, for example, a rubber ring, for example, a so-called O-ring. The holders may include projections on which the elastic element may rest. The projections may be situated in recesses of the clamping pieces, for example, so that they do not project beyond the outer contour of the clamping pieces. The recesses of the clamping pieces can face each other. The brackets may have heads, against slippage of the elastic element.

The spreading force can be produced exclusively or partially by the teeth, in particular in the embodiment in which the wedge shape of the clamping pieces is wholly or partially produced by the teeth.

A frictional connection may be advantageously produced between the clamping pieces and the first contact surfaces and, for example, between the clamping pieces and the second contact surfaces. A frictional connection may therefore be produced, for example, between the fastening piece and the profile, for example, mediated by a clamping piece. The force flow of this frictional connection advantageously does not flow through the fasteners. A relieving of the fasteners may be achieved as a result.

A relative movement between the teeth of the clamping pieces and the contact surfaces may be advantageously produced during the fastening of the fasteners, for example, also when the teeth are already in contact with the contact surfaces. A furrow of the teeth may be advantageously produced in the contact surfaces as a result. The teeth advantageously have a tapered outer contour, resulting in a particularly good furrow effect.

In an embodiment, sections of the first contact surfaces can, for example, extend parallel to the direction of force of the fasteners, or the first contact surfaces can, for example, extend completely parallel to the direction of force of the fasteners. It has been found that even with such contact surfaces, the clamping pieces may be fixed in the direction of the force direction of the fasteners.

It is in principal conceivable that sections of the second contact surfaces extend parallel to the direction of force of the fasteners, or that the second contact surfaces extend completely parallel to the direction of force of the fasteners.

In an embodiment, the fastening piece can, for example, have at least one projection which engages behind a contact surface of the profile extending parallel to the direction of force of the fasteners. The projection also advantageously extends parallel to the direction of force of the fasteners. The fastening piece thus advantageously engages behind the profile sections which provide these surfaces. As a result, spreading forces of the clamping piece can be supported and/or these sections of the profile may be pinched between the clamping piece and the projection of the fastening piece.

In an embodiment, the clamping pieces can, for example, have a shoulder, in particular in their holding position, on their side facing the first contact surface.

The shoulder can, for example, also be referred to as a nose or a projection.

In this embodiment, at least sections of the first contact surface in particular advantageously extend perpendicularly to the direction of force of the fasteners. The shoulder advantageously engages behind these sections in the holding position of the clamping pieces. The clamping pieces may also have teeth in this embodiment, in particular on their sides facing the second contact surfaces and/or on their sides facing the first contact surfaces.

In an embodiment, the clamping pieces can, for example, abut the second contact surfaces both in their assembly position, as well as in their holding position.

In an embodiment, the clamping pieces can, for example, abut the second contact surfaces only in their assembly position and are supported in their holding position merely on the first contact surfaces.

According to a third aspect, the fastening system according to the present invention has a profile. A fixing piece is also provided, as well as at least two clamping pieces. The fastening system also comprises at least two fasteners, each acting in a direction of force, which interact with the clamping pieces. The profile provides first contact surfaces for the clamping pieces and the fastening piece provides second contact surfaces for the clamping pieces.

According to this third aspect, the clamping pieces have a shoulder on their side, in particular in their holding position, facing the first contact surface.

The shoulder can, for example, also be referred to as a nose or a projection.

An elastic element is advantageously provided, which can, for example, act on the clamping pieces.

The system is used to fasten the fastening piece to the profile.

A particularly easy assembly of the fastening system may be provided as a result of the elastic element.

The fastening piece may be a band part. In an embodiment, it is not a band part. In an embodiment, it is a fitting part not used for fastening a band.

The fastening system advantageously comprises exactly one elastic element. The elastic element can, for example, act on both clamping pieces.

The fasteners advantageously each comprise a fastening screw or are formed by a fastening screw. It is also conceivable that the fasteners comprise a rivet, such as blind rivet, or are respectively formed thereby. Exactly one fastener can, for example, cooperate with exactly one clamping piece. Each clamping piece can, for example, have a threaded hole therefor.

The effect of the elastic element on the clamping pieces may be mediated by another element or other elements, such as the one or more fasteners. The elastic element can thus act on the one or on the multiple fasteners, the one or the multiple of which can transmit this effect onto the clamping pieces.

The profile can, for example, comprise aluminum.

The clamping pieces can, for example, comprise harder material than the profile. In an embodiment, the clamping pieces can, for example, comprise steel.

The fasteners can, for example, pass through the fastening piece.

The fastening piece can, for example, be situated relative to the main groove further outward than the clamping pieces.

If the elastic element acts between the clamping pieces, then an advantageous assembly of the system can be achieved in a particularly simple and effective manner. The elastic element advantageously elastically draws the clamping pieces together.

The second contact surfaces can, for example, comprise slanted guide surfaces for the clamping pieces. The guide surfaces are advantageously slanted so that they do not extend parallel and, for example, also not perpendicularly to the direction of force of the fasteners. The distance of the guide surfaces (in the assembled state of the system) can, for example, increase with increasing depth in the profile in each case to the fasteners, which cooperate with the clamping piece, for which the guide surfaces provide a contact surface. The guide surfaces can be planar or curved. If they are curved, they can, for example, be convex.

The term “direction of force of the fasteners” in the context of the present invention in particular means the direction of the main force produced by these fasteners, for example, in the fully assembled state of the system. In the case of fastening screws, this in particular means the direction from their axis, which is directed toward the fastening piece, for example, in the fully assembled state of the system. The direction of force in the assembled state of the system can, for example, extend perpendicularly to the imaginary plane in which the opening of the groove of the profile is situated.

The clamping pieces are each advantageously wedge-shaped on their side facing the second contact surface. The clamping pieces can thus, for example, each have a slanted counter guide surface on their side facing the second contact surface. The counter guide surface is advantageously slanted so that it does not extend parallel and, for example, also not perpendicularly to the direction of force of the fasteners. A displaceability of the clamping pieces from an assembly position to a holding position can thereby be improved.

A precondition may also be advantageously created for producing clamping forces and/or spreading forces via the clamping pieces. The slanted counter guide surface may comprise or be formed by teeth, such as splined teeth.

The system can be particularly easy to assemble if the elastic element is designed so that it provides the positioning of the clamping pieces relative to each other in an assembly position. The elastic element in this embodiment is namely able to relieve the assembler of the task of holding the clamping pieces in an assembly position, for example, when joining the fastening piece to the profile.

If the elastic element allows the clamping pieces to be displaced into a holding position, this then creates another precondition for a particularly easy assembly of the system. The assembler in this case does not need to remove the elastic element, for example, after joining the fastening piece to the profile. The elastic element allows the clamping pieces to be displaced, for example, as the fasteners are fastened in a holding position.

The term “assembly position of the clamping pieces” within the context of the present invention in particular refers to the position of the clamping pieces (for example, relative to each other) in the unassembled state, which enables and/or facilitates the joining of the fastening piece to the profile.

The term “holding position of the clamping pieces” within the context of the present invention in particular means the position of the clamping pieces, which these occupy in the fully assembled state of the fastening system.

The profile advantageously includes a groove. The two clamping pieces are advantageously situated next to one another in this groove in the assembled state of the system. These two clamping pieces in the assembled state are thus, for example, situated not next to each other in the longitudinal direction of the profile, but perpendicularly thereto.

The distance between the two clamping pieces in the assembly position relative to each other can, for example, be smaller than the width of the opening of the groove, so that these clamping pieces are advantageously easily insertable into the groove in the assembly direction of the joining of the clamping piece and the profile.

The distance of at least sections of two clamping pieces situated next to each other in the groove in their holding position is advantageously larger than the width of the opening of the groove. An interaction between the clamping pieces located in their holding position and the groove, such as a rear grip, is, for example, thereby possible.

The second contact surfaces are advantageously designed so that with their help, the displacement of the clamping pieces from an assembly position into a holding position may be provided by fastening the fasteners. This displacement may advantageously be provided only by fastening the fasteners. With this displacement, the distance of the clamping pieces relative to each other advantageously changes, it can, for example, increase. With this displacement, a tilting of the clamping pieces advantageously takes place, for example, so that the distance between the sections of the clamping pieces that are further away from the fastening piece increases more than the distance between the sections of the clamping pieces that are situated closer to the fastening piece. The term “fastening of the fasteners” means, for example, in the case of a screw as a fastener, the tightening thereof, for example, until this screw produces the desired main force (here tractive force). A simplification of the assembly is achieved insofar as the displacement can, for example, be provided by fastening the fastener, for example, no further action is necessary therefor.

In an embodiment, the clamping pieces can, for example, include teeth. The longitudinal extension of the teeth is advantageously parallel to the direction of force of the fasteners. The teeth can, for example, have a wedge-shaped outer contour, for example, so that they protrude farther from the clamping pieces in sections further away from the fastening piece than in sections situated closer to the fastening piece.

The wedge shape of the clamping pieces can be produced wholly or partly by the teeth. In an embodiment, therefore, the clamping pieces as such are not each already wedge-shaped but can, for example, acquire this shape only through the teeth.

As a result of the teeth, a positive connection may be advantageously produced. The positive connection can, for example, act between the clamping pieces and the fastening piece and, for example, between the clamping pieces and the profile. The positive connection thus acts, for example, between the fastening piece and the profile, for example, mediated by a clamping piece.

In the assembled state, the teeth can, for example, engage in the second contact surface. In an embodiment, the teeth in the assembled state can, for example, engage in the first contact surface. Furrows, with which the teeth advantageously form-fittingly interlock, may be produced in the first contact surfaces and/or the second contact surfaces by fastening the fasteners via the teeth.

In an embodiment, the wedge angle of the wedge shape of the clamping pieces can, for example, be less than 45°.

In an embodiment, the clamping pieces can, for example, have teeth on different, for example, on opposite, sides.

In an embodiment, the clamping pieces can, for example, have different teeth. The clamping pieces can, for example, have different teeth on different sides. As a result, the different requirements for the teeth advantageously prevailing on different sides of the clamping pieces can be taken into account.

First teeth can, for example, be provided on one side of the clamping pieces (for example, the side facing the second contact side in the assembled state) the longitudinal extension of which extends advantageously parallel to the direction of force of the fasteners, and which can, for example, further have a wedge-shaped outer contour, for example, so that they project further from the clamping pieces in sections further away from the clamping piece than in sections situated closer to the fastening piece. These first teeth advantageously produce or maintain the wedge shape of the clamping pieces, for example, implemented on this side of the clamping pieces. These first teeth can, for example, further produce spreading forces, or the displacement of the clamping pieces from the assembly position into the holding position is accomplished with their assistance. The first teeth may also be referred to as “splined teeth”.

On another, for example, the opposite, and in particular, for example, on the side of the clamping pieces which includes a shoulder, the clamping pieces advantageously include second teeth which do not produce or maintain a wedge shape of the clamping pieces. These second teeth can, for example, originate from the shoulder of the clamping pieces, more specifically, for example, from the surface of the shoulder, with which the shoulder engages behind at least sections of the first contact surface, which advantageously extend perpendicularly to the direction of force of the fasteners. These second teeth advantageously point in the direction of the force direction of the fasteners. When fastening the fasteners, these second teeth are advantageously moved perpendicularly toward this first contact surface and are further, for example, embedded in this contact surface. As a result, a positive connection and/or frictional connection is/are produced between clamping piece and profile. The second teeth may also be referred to as “vertical teeth”.

In an embodiment, the clamping pieces can, for example, include teeth on one side (for example, on the side facing the second contact surface) which advantageously produce or maintain a wedge shape of the clamping pieces on this side of the clamping pieces. These teeth may be splined teeth. The clamping pieces can, for example, further include a shoulder on the opposite side, which, for example, engages behind sections of the first contact surface, which further, for example, extends perpendicularly to the direction of force of the fasteners. The following advantage can, for example, be achieved as a result: the clamping pieces may be reliably displaced from the assembly position into the holding position and secured in the holding position with the aid of the teeth producing or maintaining the wedge shape, without a defined stop for the clamping pieces being provided on the fastening piece in the direction of force of the fasteners. This is because teeth producing or maintaining the wedge shape are able to push slightly further or less far into the fastening piece depending on manufacturing tolerances. In this way it can be provided that the force exerted by the fasteners on the clamping pieces is transmitted to a very large extent via the shoulder onto the profile where it results in the desired clamping. It has been found that to achieve this effect, it is helpful if, for example, the wedge angle of the wedge shape of the clamping pieces is less than 45°. As previously stated above, teeth, such as vertical teeth, can also be provided on the shoulder.

In an embodiment, holders for the elastic element can, for example, be provided on the clamping pieces. The elastic element can be a ring made of elastic material, for example, a rubber ring, for example, a so-called O-ring. The holders may include projections on which the elastic element may rest. The projections may be situated in recesses of the clamping pieces, in an embodiment so that they do not project beyond the outer contour of the clamping pieces. The recesses of the clamping pieces can face each other. The brackets may have heads, against slippage of the elastic element.

In an embodiment, the clamping pieces can, for example, each be wedge-shaped on two opposite sides and/or the first and second contact surfaces can extend toward each other in the direction of the force. A precondition can thereby be created for providing that the clamping pieces (advantageously in their holding position) each produce spreading forces between a first contact surface and a second contact surface.

The spreading force can be produced exclusively or partially by the teeth, in particular in the embodiment in which the wedge shape of the clamping pieces is wholly or partially produced by the teeth.

A frictional connection may be advantageously produced between the clamping pieces and the first contact surfaces and, for example, between the clamping pieces and the second contact surfaces. A frictional connection may therefore be produced, for example, between the fastening piece and the profile, for example, mediated by a clamping piece. The force flow of this frictional connection advantageously does not flow through the fasteners. A relieving of the fasteners may be achieved as a result.

A relative movement between the teeth of the clamping pieces and the contact surfaces may be advantageously produced during the fastening of the fasteners, for example, also when the teeth are already in contact with the contact surfaces. A furrow of the teeth may be advantageously produced in the contact surfaces as a result. The teeth advantageously have a tapered outer contour, resulting in a particularly good furrow effect.

In an embodiment, sections of the first contact surfaces can, for example, extend parallel to the direction of force of the fasteners, or the first contact surfaces can, for example, extend completely parallel to the direction of force of the fasteners. It has been found that even with such contact surfaces, the clamping pieces may be fixed in the direction of the force direction of the fasteners.

It is in principal conceivable that sections of the second contact surfaces extend parallel to the direction of force of the fasteners, or that the second contact surfaces extend completely parallel to the direction of force of the fasteners.

In an embodiment, the fastening piece has at least one projection which engages behind a contact surface of the profile extending parallel to the direction of force of the fasteners. The projection also advantageously extends parallel to the direction of force of the fasteners. The fastening piece thus advantageously engages behind the profile sections which provide these surfaces. As a result, spreading forces of the clamping piece can be supported and/or these sections of the profile may be pinched between the clamping piece and the projection of the fastening piece.

At least sections of the first contact surface can, for example, extend perpendicular to the direction of force of the fasteners. The shoulder advantageously engages behind these sections in the holding position of the clamping pieces. The clamping pieces may also have teeth in this embodiment, in particular on their sides facing the second contact surfaces and/or on their sides facing the first contact surfaces.

In an embodiment, the clamping pieces can, for example, abut the second contact surfaces both in their assembly position, as well as in their holding position.

In an embodiment, the clamping pieces can, for example, abut the second contact surfaces only in their assembly position and are supported in their holding position merely on the first contact surfaces.

The present invention will be explained in greater detail below under reference to exemplary embodiments as shown in the drawings.

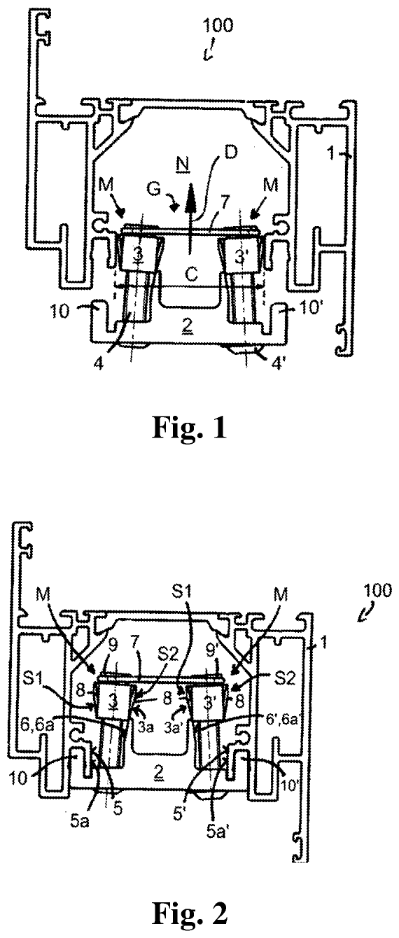

FIGS. 1-3 show a first exemplary embodiment of a system according to the present invention identified as a whole by 100.

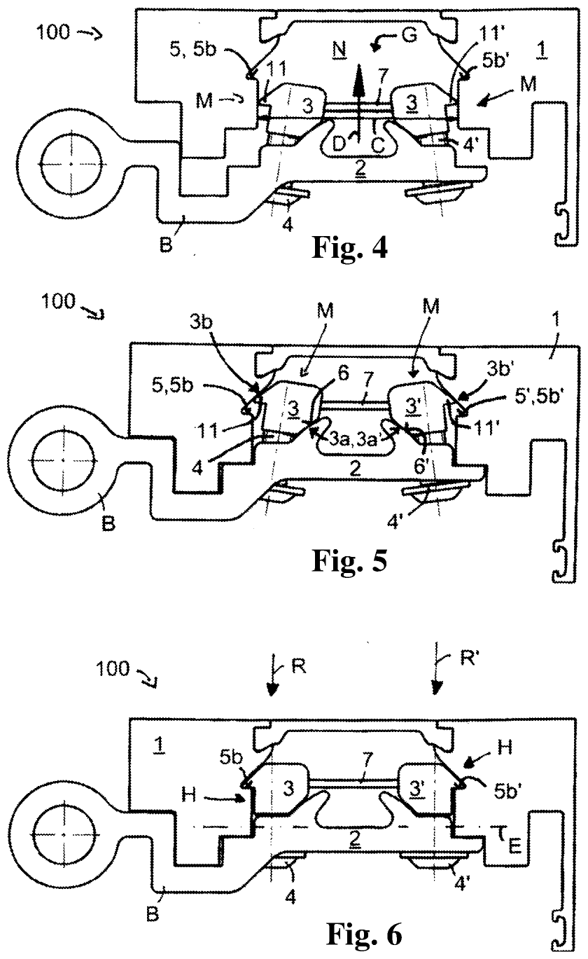

FIGS. 4-6 show a second exemplary embodiment, also identified as a whole by 100.

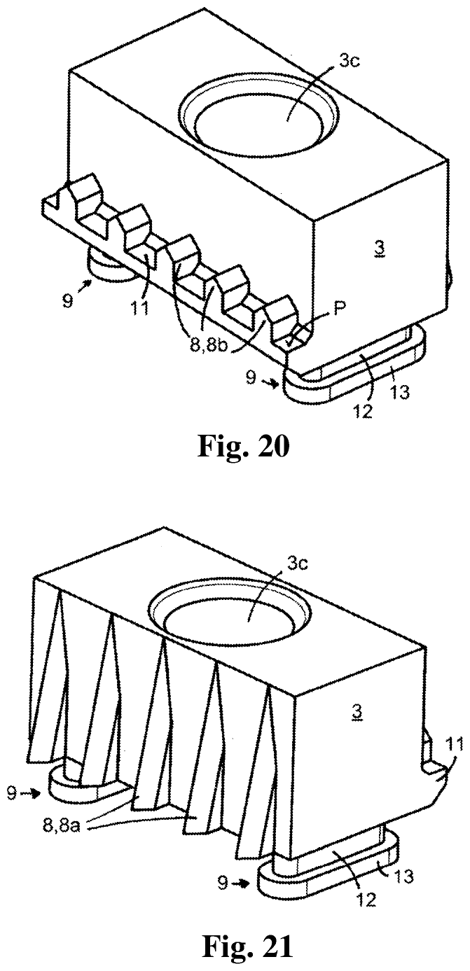

FIGS. 12-21 also show a third exemplary embodiment, also identified as a whole by 100.

FIGS. 1, 4 and 12 show the assembly direction D when joining the fastening piece 2 and the profile 1 and the width C of the opening G of the groove N of the profile 1.

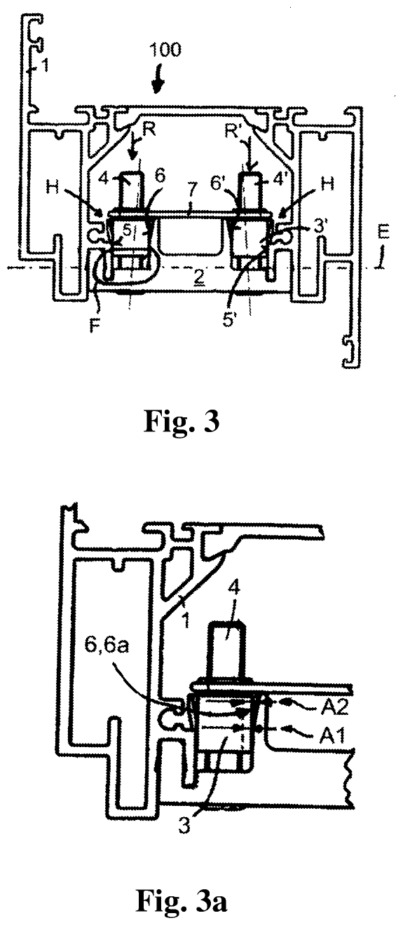

All exemplary embodiments of the system according to the present invention shown comprise a profile 1 and a fastening piece 2. In addition, all exemplary embodiments shown comprise exactly two clamping pieces 3, 3′ and exactly two fasteners 4, 4′, which cooperate with the clamping pieces 3, 3′ and are designed as fastening screws. The fastening screws cooperate in all exemplary embodiments shown with threaded holes 3c of the clamping pieces 3, 3′ together. The direction of force R, R′ in all exemplary embodiments shown extends in the assembled state of the system 100 perpendicularly to the imaginary plane E, in which the opening G of the groove N of the profile 1 is located. In all the exemplary embodiments shown, the profile 1 provides first contact surfaces 5, 5′ for the clamping pieces 3, 3′, which are abutted by the clamping pieces 3, 3′ rest in their holding position H (see FIGS. 3, 6 and 14). In all exemplary embodiments, second attachment surfaces 6, 6′ are also provided on the fastening piece 2 for the clamping pieces 3, 3′.

All exemplary embodiments shown also comprise an elastic element 7, which acts between the clamping pieces 3, 3′ and which draws the latter toward each other.

The second contact surfaces 6, 6′ in all exemplary embodiments comprise slanted guide surfaces 6a, 6a′, and the clamping pieces 3, 3′ are each wedge-shaped on their side 3a, 3a′ facing the second contact surface 6, 6′.

In the first and third exemplary embodiments, the slanted guide surfaces 6a, 6a′ are planar, in the second exemplary embodiment, they are convex.

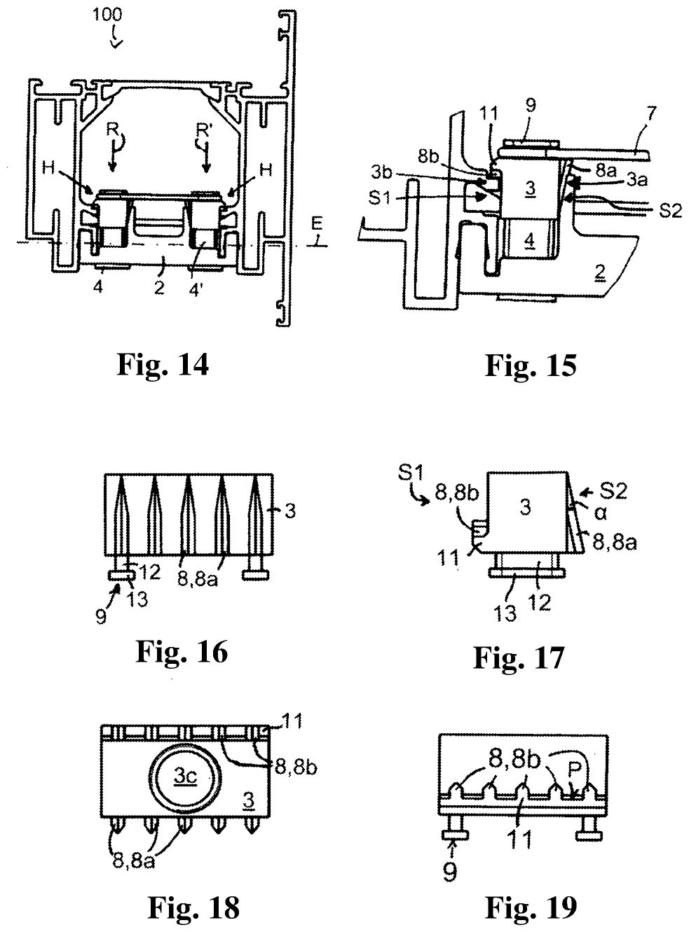

The elastic element 7 in all exemplary embodiments is designed so that it provides the positioning of the clamping pieces 3, 3′ relative to each other in an assembly position M and allows the displacement of the clamping pieces into a holding position H. This displacement is produced in all exemplary embodiments, starting from the position in FIG. 2 or FIG. 5, or FIG. 13, by fastening the fasteners 4, 4′, i.e., by tightening the fastening screws (see FIGS. 2 and 3, or FIGS. 5 and 6, or FIGS. 13 and 14).

The second contact surfaces 6, 6′ are designed so that with their help, the displacement of the clamping pieces 3, 3′ from the assembly position M into the holding position H is produced by fastening the fasteners. As a comparison of FIGS. 2 and 3 and FIGS. 5 and 6 and FIGS. 13 and 14 shows, the distance between the clamping pieces 3, 3′ increases during this displacement, and a tilting of the clamping pieces 3, 3′ takes place.

When tightening the fastening screws, the clamping pieces 3, 3′ slide along on the second contact surfaces 6, 6′, which causes an increase in the distance between the two clamping pieces to each other and a tilting of the clamping pieces 3, 3′.

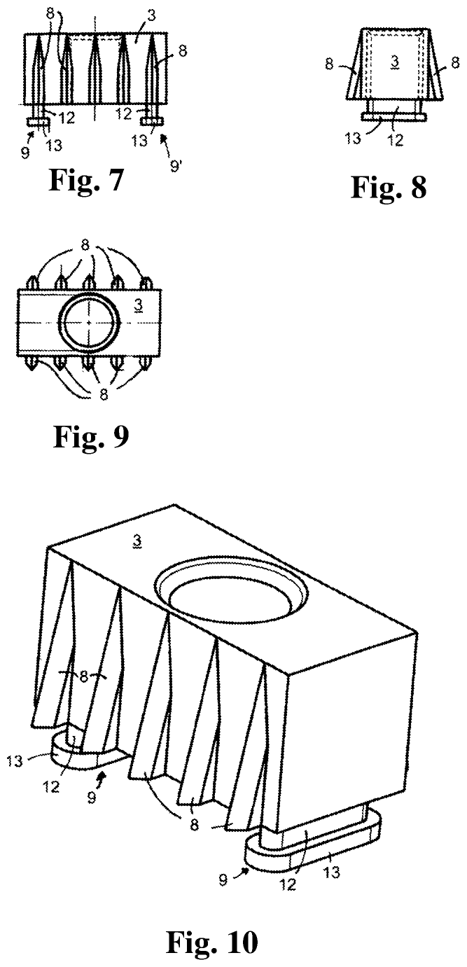

As shown in the first and third exemplary embodiments, the clamping pieces 3, 3′ of all the exemplary embodiments shown may include teeth 8. The teeth 8 of the exemplary embodiment shown in FIGS. 4-6 (not shown in the drawings) may be the same or similar to those of the teeth 8 of the exemplary embodiment shown in FIGS. 1-3a and FIGS. 7-10.

The clamping pieces 3, 3′ of all exemplary embodiments shown can include holders 9, 9′ for the elastic element 7.

In the exemplary embodiment shown in FIGS. 1-3, the clamping pieces 3, 3′ are wedge-shaped not only on their side 3a facing the second contact surfaces 6, 6′, but on two opposite sides S1, S2. As can be seen therefrom, this wedge shape is caused exclusively by the teeth 8. FIGS. 7-10, for example, show that the remaining clamping piece 3 is not wedge-shaped, but cuboid-shaped. In the exemplary embodiment shown in FIGS. 1-3, at least sections of the first contact surfaces 5, 5′ extend parallel to the direction of force R, R′ of the fasteners 4, 4′, i.e., parallel to the axis of the fastening screws in their holding position H. More precisely, the first contact surfaces 5, 5′ here extend completely parallel to the direction of force R, R′ of the fasteners 4, 4′. The clamping pieces 3, 3′ in this exemplary embodiment produce spreading forces in their holding position H between the fastening piece 2 and the profile 1. FIG. 3 shows that the force flow F of these spreading forces does not extend through the fasteners 4, i.e., the fasteners 4 are relieved thereof and the spreading forces act directly between the fastening piece 2 and profile 1, mediated by a clamping piece 3. In this exemplary embodiment, the clamping pieces 3, 3′ in their holding position H abut the first contact surfaces 5, 5′ and the second contact surfaces 6, 6′.

FIGS. 1-3 also show that the fastening piece 2 shown in this exemplary embodiment has two projections 10, 10′, each of which engages behind a contact surface 5a, 5a′ of the profile extending parallel to the direction of force R of the fasteners 4, 4′. The fastening piece 2 in this exemplary embodiment is designed as a fitting part, which is not used for fastening a band.

FIG. 3a illustrates that the distance between the second contact surfaces 6, 6′ designed as slanted guide surfaces 6a, 6a′ and the fastener 4, which interacts with the clamping piece 3, for which they provide a contact surface (in the assembled state of the system) increases from a first distance A1 with increasing depth into the profile in each case to a second distance A2.

One of the two clamping pieces 3, 3′ of the exemplary embodiment shown in FIGS. 1-3 is shown in greater detail in the FIGS. 7-10. Apparent, among other things, are the holders 9, 9′ for the elastic element 7, which are formed from a projection 12 and from a head 13 of this projection. As can be seen, for example, in FIGS. 16, 20 and 21, the clamping pieces 3, 3′ of the third exemplary embodiment also include holders 9, 9′ with a projection 12 and a head 13.

In the exemplary embodiments shown in FIGS. 4-5 and 12-21, the clamping pieces 3, 3′ are wedge-shaped only on their side 3a, 3a′ facing the second contact surfaces 6, 6′. On the opposite side, i.e., on the sides 3b, 3b′ facing the first contact surfaces 5, 5′, the clamping pieces include a shoulder 11.

The first contact surfaces 5, 5′ in these exemplary embodiments are designed so that at least sections 5b, 5b′ extend perpendicularly to the direction of force R of the fasteners 4, 4′. As shown in FIGS. 6 and 14, the shoulders 11 in the holding position H of the clamping pieces 3, 3′ engage behind these sections 5b, 5b′ of the first contact surfaces 5, 5′ that extend perpendicularly to the direction of force R, R′. The fastening piece 2 in the second exemplary embodiment is designed as part of a band B. In this embodiment as well, the clamping pieces 3, 3′ may include teeth 8 on their sides 3a, 3a′ facing the second contact surfaces 6, 6′ (not shown in the drawings).

In one not shown modification of all shown exemplary embodiments in the drawings, the elastic element 7 is omitted in each case.

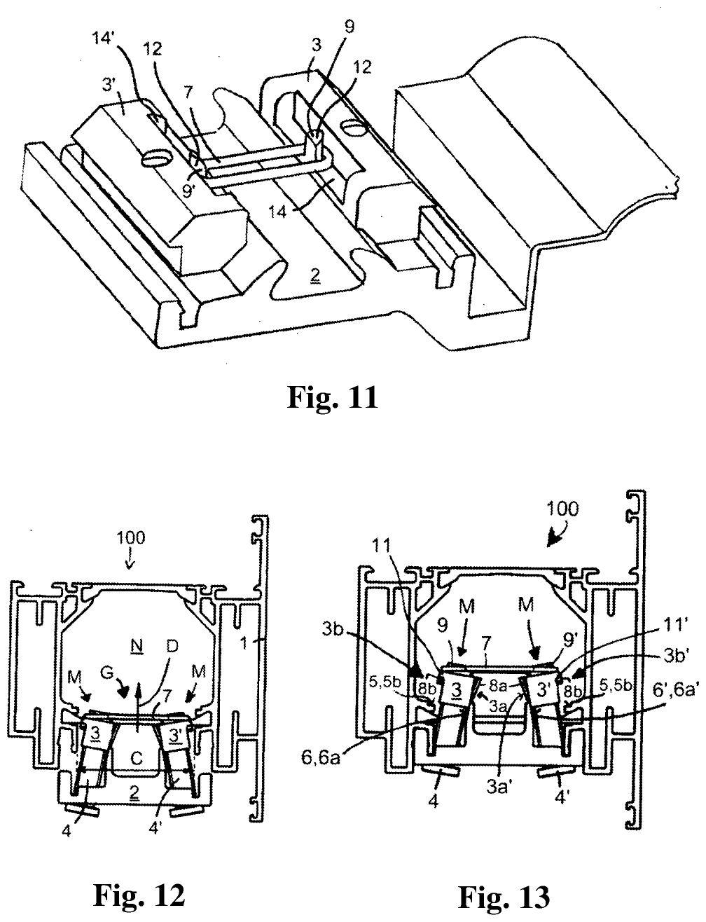

FIG. 11 shows a detail of the exemplary embodiment shown in FIGS. 4-6 in a perspective view and on a larger scale. It is apparent that the clamping pieces 3, 3′ include holders 9, 9′ for the elastic element 7, with projections 12 which are situated in recesses 14, 14′ of the clamping pieces 3, 3′ so that they do not protrude beyond the outer contour of the clamping pieces. The recesses 14, 14′ of the clamping pieces 3, 3′ face each other.

The wedge angle α of the wedge shape of the clamping pieces 3, 3′ is less than 45° in the first and third exemplary embodiments shown (see, for example, FIG. 17).

In the third embodiment, the clamping pieces 3, 3′ include splined teeth 8a on side 3a, 3a′ facing the second contact surface, which produce a wedge shape of the clamping pieces on this side of the clamping pieces (see, for example, FIGS. 16-19). On the opposite side, the clamping pieces 3, 3′ include a shoulder 11, which engages behind sections 5b, 5b′ of the first contact surface 5, 5′, which extend perpendicularly to the direction of force R, R′ of the fasteners 4, 4′. The result that may be achieved hereby is, in particular, that the force exerted on the clamping pieces 3, 3′ by the fasteners 4, 4′ is transmitted to the profile 1 to a very large extent via the shoulder 11 where it results in the desired clamping (see, for example, FIG. 15).

In the third embodiment, the clamping pieces 3, 3′ include teeth 8 on opposite sides S1, S2. The teeth 8 on opposite sides S1, S2 are different from each other.

On one side of the clamping pieces, specifically, on the side 3a, 3a′ facing the second contact surface 6, 6′ in the assembled state, splined teeth 8a are provided, the longitudinal extent of which extends parallel to the direction of force R, R′ of the fasteners 4, 4′, and which have a wedge-shaped outer contour, such that in sections further away from the fastening piece 2, they project further away from the clamping pieces 3, 3′, than in sections situated closer to the fastening piece 2. These splined teeth 8a produce the wedge shape of the clamping pieces 3, 3′ implemented on this side of the clamping pieces 3, 3′, and they produce spreading forces or, the displacement of the clamping pieces 3, 3′ from the assembly position M into the holding position H is accomplished with their help.

On the opposite side, specifically, on the side of the clamping pieces 3, 3′ that includes the shoulder 11, the clamping pieces 3, 3′ advantageously include perpendicular teeth 8b, which produce no wedge shape of the clamping pieces. These perpendicular teeth 8b arise from the shoulder 11 of the clamping pieces, more precisely, from the surface P of the shoulder 11, with which the shoulder engages behind at least sections of the first contact surface 5b, 5b′, which extend perpendicularly to the direction of force R, R′ of the fasteners 4, 4′. These perpendicular teeth 8b point in the direction of the force direction R, R′ of the fasteners 4, 4′. When fastening the fasteners 4, 4′, these perpendicular teeth 8b are moved perpendicularly to this first contact surface 5b, 5b′ and embed themselves therein.

The present invention is not limited to embodiments described herein; reference should be had to the appended claims.

### LIST OF REFERENCE NUMERALS

100 Fastening system
1 Profile
2 Fastening piece
3, 3′ Clamping pieces
3a, 3a′ Side of the clamping pieces facing the second contact surface
3b, 3b′ Side of the clamping pieces facing the first contact surface
3c Threaded hole
4, 4′ Fasteners
5, 5′ First contact surfaces
5a, 5a′ First contact surfaces extending parallel to the direction of force
5b, 5b′ First contact surfaces extending perpendicularly to the direction of force
6, 6′ Second contact surfaces
6a, 6a′ Guide surfaces
7 Elastic element
8 Teeth
8a Splined teeth
8b Vertical teeth
9, 9′ Holders
10, 10′ Projection of the fastening piece
11, 11′ Shoulder
12 Projection
13 Head
14, 14′ Recesses
A1 Distance
A2 Distance
B Band section
C Width of the opening of the groove
D Assembly direction
E Imaginary plane in which the opening of the groove lies
G Opening of the groove
F Force flow
H Holding position
M Assembly position
N Groove
P Surface of the shoulder
R, R′ Direction of force
S1, S2 Opposite sides of the clamping piece
α Wedge angle

What is claimed is:

1-38. (canceled)

39. A fastening system comprising:
a profile;
a fastening piece;
at least two clamping pieces;
at least two fasteners, each of the at least two fasteners being configured to act in a direction of force and to cooperate with a respective one of the at least two clamping pieces; and
an elastic element configured to act on each of the at least two clamping pieces,
wherein,
the profile provides a first contact surface for each of the at least two clamping pieces, and
the fastening piece provides a second contact surface for each of the at least two clamping pieces.

40. The fastening system as recited in claim 39, wherein the elastic element is configured to act between the at least two clamping pieces.

41. The fastening system as recited in claim 39, wherein the second contact surface comprises a slanted guide surface for each of the at least two clamping pieces.

42. The fastening system as recited in claim 39, wherein each of the at least two clamping pieces are configured to have a wedge-shape which is arranged on a side which faces the second contact surface.

43. The fastening system as recited in claim 39, wherein the elastic element is configured to provide a positioning of the at least two clamping pieces relative to each other in an assembly position and to allow a displacement of the at least two clamping pieces into a holding position.

44. The fastening system as recited in claim 43, wherein the second contact surface is configured so that the displacement of the at least two clamping pieces from the assembly position into the holding position is provided by fastening the at least two fasteners.

45. The fastening system as recited in claim 39, wherein each of the at least two clamping pieces comprise teeth.

46. The fastening system as recited in claim 45, wherein,
the teeth of the at least two clamping pieces are arranged on a first side which faces the second contact surface, the teeth being configured to produce or to maintain a wedge shape of the at least two clamping pieces on the first side, and
the each of the at least two clamping pieces further comprise a shoulder on a second side which is opposite to the first side.

47. The fastening system as recited in claim 39, further comprising:
holders for the elastic element, the holders being arranged on the at least two clamping pieces.

48. The fastening system as recited in claim 39, wherein the at least two clamping pieces are each configured to at least one of,
have a wedge-shape on a first side and on a second side which is opposite to the first side, and
have the first contact surface and the second contact surface arranged to converge in the direction of force.

49. The fastening system as recited in claim 48, wherein at least sections of the first contact surface extend parallel to the direction of force.

50. The fastening system as recited in claim 49, wherein the fastening piece comprises at least one projection which is configured to engage behind the sections of the first contact surface which extend parallel to the direction of force.

51. The fastening system as recited in claim 39, wherein each of the at least two clamping pieces comprise a shoulder which is arranged on a side facing the first contact surface.

52. The fastening system as recited in claim 51, wherein at least sections of the first contact surface are arranged to extend perpendicular to the direction of force.

53. A fastening system comprising:
a profile;
a fastening piece;
at least two clamping pieces; and
at least two fasteners, each of the at least two fasteners being configured to act in a direction of force and to cooperate with a respective one of the at least two clamping pieces;
wherein,
the profile provides a first contact surface for each of the at least two clamping pieces,
the fastening piece provides a second contact surface for each of the at least two clamping pieces, and
each of the at least two clamping pieces are configured to have a wedge-shape on a first side which faces the second contact surface.

54. The fastening system as recited in claim 53, further comprising an elastic element which is configured to act on each of the at least two clamping pieces.

55. The fastening system as recited in claim 54, wherein the elastic element is configured to act between the at least two clamping pieces.

56. The fastening system as recited in claim 54, wherein the elastic element is further configured to provide a positioning of the at least two clamping pieces relative to each other in an assembly position and to allow a displacement of the at least two clamping pieces into a holding position.

57. The fastening system as recited in claim 59, wherein the second contact surface is configured so that the displacement of the at least two clamping pieces from the assembly position into the holding position is provided by fastening the at least two fasteners.

58. The fastening system as recited in claim 53, wherein the second contact surface comprises a slanted guide surface for each of the at least two clamping pieces.

59. The fastening system as recited in claim 53, wherein each of the at least two clamping pieces comprise,
teeth which are arranged on the first side which faces the second contact surface, the teeth being configured to produce or maintain the wedge shape of the at least two clamping pieces on the first side, and
a shoulder which is arranged on a second side which is opposite to the first side.

60. The fastening system as recited in claim 53, wherein the at least two clamping pieces are each configured to at least one of,
have the wedge-shape on the first side and a wedge-shape on a second side which is opposite to the first side, and
have the first contact surface and the second contact surface arranged to converge in the direction of force.

61. The fastening system as recited in claim 53, wherein each of the at least two clamping pieces comprise teeth.

62. The fastening system as recited in claim 53, further comprising:
an elastic element which is configured to act on each of the at least two clamping pieces; and
a holder for the elastic element arranged on each of the at least two clamping pieces.

63. The fastening system as recited in claim 53, wherein,
each of the at least two clamping pieces comprise teeth, and
the wedge-shape is produced by the teeth.

64. The fastening system as recited in claim 53, wherein at least sections of the first contact surface extend parallel to the direction of force.

65. The fastening system as recited in claim 64, wherein the fastening piece comprises at least one projection which is configured to engage behind the sections of the first contact surface which extend parallel to the direction of force.

66. A fastening system comprising:
a profile;
a fastening piece;
at least two clamping pieces; and
at least two fasteners, each of the at least two fasteners being configured to cooperate with a respective one of the at least two clamping pieces;
wherein,
the profile provides a first contact surface for each of the at least two clamping pieces,
the fastening piece provides a second contact surface for each of the at least two clamping pieces, and
each of the at least two clamping pieces comprises a shoulder on a first side which faces the first contact surface.

67. The fastening system as recited in claim 66, further comprising an elastic element which is configured to act on each of the at least two clamping pieces.

68. The fastening system as recited in claim 67, wherein the elastic element is further configured to act between the at least two clamping pieces.

69. The fastening system as recited in claim 66, wherein the second contact surface comprises a slanted guide surface for each of the at least two clamping pieces.

70. The fastening system as recited in claim 66, wherein each of the at least two clamping pieces is configured to have a wedge-shape on a second side which faces the second contact surface.

71. The fastening system as recited in claim 66, wherein the elastic element is configured to provide a positioning of the at least two clamping pieces relative to each other in an assembly position and to allow a displacement of the at least two clamping pieces into a holding position.

72. The fastening system as recited in claim 71, wherein the second contact surface is configured so that the displacement of the at least two clamping pieces from the assembly position into the holding position is provided by fastening the at least two fasteners.

73. The fastening system as recited in claim 66, wherein each of the at least two clamping pieces comprise teeth.

74. The fastening system as recited in claim 63, wherein each of the at least two clamping pieces comprise,
teeth on a second side which faces the second contact surface, the teeth being configured to produce or to maintain a wedge-shape of each of the at least two clamping pieces on the second side, and
a shoulder on the first side which is opposite to the second side.

75. The fastening system as recited in claim 66, further comprising:
an elastic element which is configured to act on each of the at least two clamping pieces; and
a holder for the elastic element arranged on each of the at least two clamping pieces.

76. The fastening system as recited in claim 66, wherein at least sections of the first contact surface extend perpendicular to a direction of force of the at least two fasteners.
